(19) United States
(12) Patent Application Publication
(10) Pub. No.: US 2026/0320969 A1
(43) Pub. Date: Oct. 15, 2026

(54) SYSTEMS AND METHODS FOR SINGLE POINT IMAGE MATCHING

(71) Applicant: Rivet Industries, Inc., Washington, DC (US)

(72) Inventors: Seyedsohrab MADANI, Menlo Park, CA (US); Harish Babu MANOGARAN, Menlo Park, CA (US); Jouya JADIDIAN, Los Gatos, CA (US)

(21) Appl. No.: 19/642,282

(22) Filed: Apr. 8, 2026

Related U.S. Application Data
(60) Provisional application No. 63/788,968, filed on Apr. 15, 2025.

(51) Int. Cl. G06V 10/75; G06V 10/25; G06V 10/74

(52) U.S. Cl. CPC G06V 10/759; G06V 10/25; G06V 10/757; G06V 10/761

(57) ABSTRACT

A method includes identifying a query point at a first image. The method further includes identifying, using a first matching technique, a set of regions at the first image that match a set of regions at the second image. The method further includes filtering, based on the query point, the set of regions at the first image to identify a filtered region from the first image. The method further includes identifying a region of interest at the second image corresponding to the filtered region. The method further includes analyzing, using a second matching technique that is more computationally complex than the first matching technique, the region of interest for a point that matches the query point. The method further includes outputting a representation of the point.

### CROSS REFERENCE TO RELATED APPLICATION

This application claims priority to U.S. Provisional Patent Application No. 63/788,968, filed on Apr. 15, 2025 and titled, “Systems and Methods for Single Point Image Matching,” the entirety of which is herein incorporated by reference.

### FIELD

One or more embodiments relate to systems and methods for single point matching.

### BACKGROUND

Some known image matching systems are often inaccurate and computationally inefficient. Some known methods generate numerous point correspondences between two images, which leads to substantial computational overhead. Furthermore, these known systems typically depend heavily on interpolation when points of interest are not directly matched, introducing additional errors and undermining accuracy. This reliance on interpolation and the excessive computation of potentially irrelevant matches waste computational resources. The inaccuracies introduced by interpolation approximations further exacerbate the issue, reducing the reliability of results. As a result, these limitations impose higher computational costs while having undesirable accuracy, creating barriers for real-time implementation. Accordingly, techniques that match specific points of interest between images more efficiently and accurately can be desirable.

### SUMMARY

In some embodiments, a method includes identifying a query point at a first image. The method further includes identifying, using a first matching technique a set of regions at the first image that match a set of regions at a second image. The method further includes filtering, based on the query point, the set of regions at the first image to identify a filtered region from the first image. The method further includes identifying a region of interest at the second image corresponding to the filtered region. The method further includes analyzing, using a second matching technique that is more computationally complex than the first matching technique, the region of interest for a point that matches the query point. The method further includes outputting a representation of the point.

In some embodiments, a head-mounted display includes a set of cameras. The head-mounted display also includes a display. The head-mounted display also includes a processor that is operatively coupled to at least one of the set of cameras or the display. The processor is configured to cause the set of cameras to capture a first image and a second image. The processor is also configured to identify a query point at the first image. The processor is also configured to identify, using a first matching technique, a set of regions at the first image that match with a set of regions at the second image. The processor is also configured to filter, based on the query point, the set of regions at the first image to identify a filtered region from the first image. The processor is also configured to identify a region of interest at the second image that corresponds to the filtered region. The processor is also configured to analyze, using a second matching technique that is more computationally complex than the first matching technique, the region of interest for a point that matches the query point. The processor is also configured to output a representation of the point.

In some embodiments, a non-transitory, processor-readable medium stores instructions that, when executed by at least one processor, cause the at least one processor to identify a query point at a first image. The at least one processor is also caused to identify, using a first matching technique, a set of regions at the first image that match with a set of regions at a second image. The at least one processor is also caused to filter, based on the query point, the set of regions at the first image to identify a filtered region from the first image. The at least one processor is also caused to identify a region of interest at the second image that corresponds to the filtered region. The at least one processor is also caused to analyze, using a second matching technique that is more computationally complex than the first matching technique, the region of interest for a point that matches the query point. The at least one processor is also caused to cause display of a representation of the point.

### BRIEF DESCRIPTION OF THE DRAWINGS

FIG. 1 illustrates a system block diagram to match points at images, according to an embodiment.

FIG. 2A is a diagram illustrating an example of a known approach to matching.

FIG. 2B is a diagram illustrating matching using an identified region of interest, according to an embodiment.

FIG. 3 is a flowchart of a method to determine a corresponding point, according to an embodiment.

FIG. 4 illustrates a flowchart of a method to identify a point at a second image matching a query point at a first image, according to an embodiment.

### DETAILED DESCRIPTION

Some implementations are related to a direct query-based point matching technique that identifies the corresponding location of a specific query point from one image in another image without generating comprehensive point correspondences across either image. Unlike known techniques that generate numerous matches then interpolate, some implementations described herein (1) directly target the specific point of interest, (2) focus computational resources on relevant regions and without focusing on non-relevant regions, and (3) produce more accurate results compared to known techniques by avoiding interpolation errors. In some implementations, targeted, hierarchy matching is used that prioritizes efficiency and accuracy for single point correspondence, as described in the following paragraph and with respect to some embodiments herein.

In some implementations, a user or a compute device identifies a specific point of interest in a first image (sometimes referred to herein as a “query point”). Matching then occurs, where coarse/sparse, computationally inexpensive matches are identified between the first image and the second image. The matches can represents regions (e.g., pixel groupings) at the first image that also appear to be at the second image. An example of match could be, for example, a target at the first image and the same target at the second image. Those matches are then filtered to identify a region(s) at the first image close to the query point (referred to herein as “a filtered region(s)”), where closeness can be determined using, for example, Euclidiean distance in image space, feature space similarity, semantic relevance, and/or the like. In some implementations, in response to the filtered region(s) at the first image close to the query point being identified, the region(s) at the second image corresponding to the filtered region(s) at the first image close to the query point represents a region(s) of interest. A more focused refinement can then occur at the region(s) of interest, where a more intensive matching technique is used at the region(s) of interest (and not regions outside the region(s) of interest) to determine and output the precise point corresponding to the query point in the second image.

In an example, a first image-Image A-and a second image-Image B-are received from one or more cameras. A query point (Pg) is identified at Image A. For example, a user may select the query point at Image A using a mouse or via touch. As another example, a compute device can determine the query point without user intervention. A set of one or more regions at the first image that match with a set of one or more regions at the second image{(pᵢ^{A}, pᵢ^{B})} can be generated/determined using a first matching technique, where each match refers to a region at Image A that is also a region at Image B. For example, if image A captures a first scene and a second scene while image B captures the first scene but not the second scene, the match could be the pixel group(s) representing the first scene but could not be the pixel group(s) representing the second scene. The set of one or more regions at the first image can then be filtered to retain just those matches where the distance, feature space similarity, and/or semantic relevance between pi and the query point is within a predetermined acceptable range, to define what is sometimes referred to herein as a “filtered region.” A region of interest is defined at Image B corresponding to (e.g., matching) the filtered region of Image A and a fine-grained matching algorithm(s) is applied, based on the filtered region of Image A, at the region of interest of Image B and not other regions of Image B. By focusing computation resources on the relevant region(s) of Image B—the region of interest—instead of all regions (or regions in addition to a region of interest) of Image B, computational burden is decreased while improving accuracy since matching is done directly to the query point rather than through interpolation.

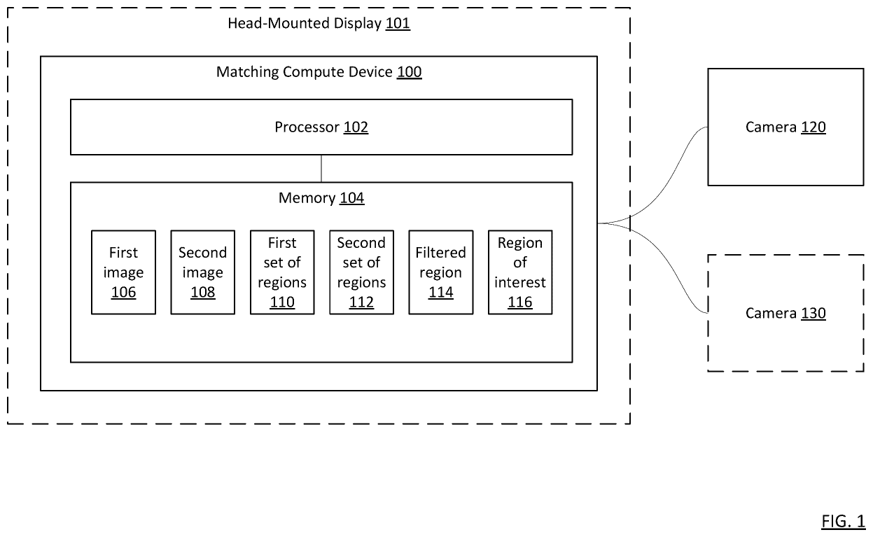

FIG. 1 illustrates a system block diagram to match points at images, according to an embodiment. FIG. 1 includes optional head-mounted display 101, matching compute device 100, camera 120, and optional camera 130. Matching compute device 100 can be operatively coupled to camera 120. In some implementations, camera 120 (and, in some instances, optional camera 130) can be collocated with matching compute device 100. For example, camera 120 can be a camera of (or within, attached to) head-mounted display 101 and/or a camera of (or within, attached to) a smartphone, a smart tablet, a smart display, a smart security camera (e.g., a video doorbell), and/or the like. In some implementations, camera 120 (and, in some instances, optional camera 130) can be remote from matching compute device 100. For example, camera 120 can be wirelessly connected to matching compute device 100 via a network (not shown in FIG. 1). In some implementations, camera 120 can be collocated with matching compute device 100 and camera 130 can be remote from matching compute device 100. In some implementations, camera 120 can be remote from matching compute device 100 and camera 130 can be collocated with matching compute device 100.

Camera 120 can be a device that produces images and/or image feeds (or image frames) of a video by detecting electromagnetic radiation. In some implementations, camera 120 can be a thermal camera (also referred to herein as a thermal imager) configured to produce thermal images by detecting thermal infrared (IR) radiation. Thermal IR radiation can include, for example, light having a wavelength from a mid-wave infrared spectral band (e.g., about 3 microns to about 5 microns) and/or light having a wavelength from a long-wave infrared spectral band (e.g., about 8 microns to about 14 microns). In some implementations, camera 120 can be a visible light camera configured to produce visible light images by detecting reflected visible light or at least a portion of the visible light spectrum. In some implementations, camera 120 can be a low-light camera configured to produce low light images by detecting low-light radiation. Low-light radiation can include, for example, light having a wavelength from a near-infrared spectral band (e.g., about 750 nm to about 1.1 microns). Optional camera 130 can be structurally and/or functionally similar to camera 120. In some implementations, camera 120 can be of a camera type different from a camera type of optional camera 130. For example, camera 120 can be a thermal camera and optional camera 130 can be a low light camera.

Matching compute device 100 can be any type of compute device, such as a sensor, a server, a desktop, a laptop, a tablet, a phone, and/or the like. In some implementations, matching compute device 100 can be included with (or within) head-mounted display 101. Matching compute device 100 includes processor 102 and memory 104. Processor 102 can be operatively coupled to memory 104 (e.g., via a system bus).

Processor 102 can be, for example, a hardware-based integrated circuit (IC) or any other suitable processing device configured to run or execute a set of instructions or a set of codes. For example, processor 102 can include a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC), a graphics processing unit (GPU), a neural network processor (NNP), and/or the like. Processor 102 can be operatively coupled to memory 104 through a system bus (for example, address bus, data bus, and/or control bus). Memory 104 can store electronic information. The term memory may refer to various types of processor-readable media such as, for example, random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc.

Memory 104 includes (e.g., stores) first image 106 and second image 108. First image 106 can include at least one point (e.g., at least one pixel) that is identical to a point at second image 108. In other words, a first pixel representing a query point at first image 106 exists as a second pixel at second image 108. For example, first image 106 can include an object at a first scene, and second image 108 can include the same object but at a different scene. In some instances, a query point in first image 106 can be and/or include a pixel from the pixel grouping that represents the object at the first scene. In some implementations, first image 106 and second image 108 are not identical. For example, first image 106 can have a field-of-view that is different from a field-of-view of second image 108 to cause first image 106 to capture a perspective of the shared object that is different from the perspective of the shared object captured by second image 108. In some implementations, first image 106 and second image 108 can be captured by the same camera 120. In some implementations, first image 106 and second image 108 can be captured by different cameras. For example, first image 106 can be captured by camera 120 (e.g., a first type of camera), and second image 108 can be captured by camera 130 (e.g., a second type of camera). For example, the first image 106 can be captured by camera 120 implemented as, for example, a thermal imager that is operatively coupled to head-mounted display 101, and the second image 108 can be captured by camera 130 implemented as, for example, a low-light camera that is operatively coupled to head-mounted display 101. First image 106 and second image 108 can be captured at the same time or at different times.

A query point can be identified at first image 106. The query point can represent, for example, a specific location or feature within first image 106 that the user wants or the compute device identifies to find at second image 108. In some implementations, a user selects the query point at first image 106 (e.g., manually clicking on a spot in first image 106 using, for example, a cursor or touch interface) to cause registration of the query point by processor 102. In some implementations, processor 102 can be configured to select the query point. For example, the processor 102 can select the query point based on predetermined criteria (e.g., center, edge, most salient feature, etc.) and/or in connection with a task such a tracking an object across multiple frames of multiple camera views, 3D reconstruction, etc.

Memory 104 can also include (e.g., store) first set of regions 110 and second set of regions 112. First set of regions 110 can include one or more regions from first image 106, and second set of regions 112 can include one or more regions from second image 108. First set of regions 110 represents a region(s) from first image 106 that match a region(s) at second image 108. Second set of regions 112 represents a region(s) from second image 108 that match with a region(s) at first image 106. Thus, first set of regions 110 matches second set of regions 112. First set of regions 110 and second set of regions 112 can be determined using a first matching technique. For example, processor 102 can be configured to determine first set of regions 110 and second set of regions 112 based on a first matching technique.

Memory 104 can also include (e.g., store) filtered region 114. Filtered region 114 can be identified by comparing first set of regions 110 to the query point at first image 106 and filtering out (e.g., removing) regions from first set of regions 110 not meeting a predetermined set of one or more criteria. Said differently, first set of regions 110 is filtered to generate filtered region 114 by identifying, for example, one or more filtered regions from first set of regions 110 having a Euclidean distance to the query point within a predetermined acceptable range, feature space similarity to the query point within a predetermined acceptable range, and/or semantic relevance to the query point within a predetermined acceptable range. For example, processor 102 can be configured to filter (e.g., remove) a subset of regions from the first set of regions 110 to generate (or define) filtered region 114, the subset of regions being region(s) that do not meet a predetermined set of one or more criteria associated with the query point, the filtered region 114 being a region that does meet the predetermined set of one or more criteria associated with the query point.

Region of interest 116 can then be identified at second image 108 based on filtered region 114. In some implementations, region of interest 116 corresponds to filtered region 114. Said differently, filtered region 114 matches region of interest 116. Thus, region of interest 116 can be identified by determining the region at second image 108 that matches filtered region 114. For example, processor 102 can be configured to determine (or identify) the region in second image 108 that matches filtered region 114, to define region of interest 116 in second image 108.

A second matching technique can be applied within region of interest 116 (and not regions of second image 108 outside region of interest 116) to identify a point that matches to the query point. The second matching technique applied here can be more computationally complex (e.g., different Big O notation, takes up more memory, uses more processing power, etc.) than the first matching technique used to identify first set of regions 110 and second set of regions 112. In some implementations, an indication (e.g., coordinate values or other indicators) of the point within region of interest 116 matching to the query point identified at first image 106 can be output. For example, the point matching to the query point identified at first image 106 can be highlighted or otherwise emphasized at second image 108. For another example, an indication (e.g., coordinate values or other indicators) of the point matching to the query point identified at first image 106 can be stored for further processing (e.g., tracking an object, 3D reconstruction, etc.). For example, processor 102 can be configured to identify a point (e.g., a pixel) in region of interest 116 that matches the query point, based on a second matching technique that is more computationally complex than the first matching technique.

In some implementations, a machine learning model (e.g., convolutional neural network, geometric transformation model, graph-based matching model, and/or the like) can be trained using a query point at first image 106 and corresponding point at second image 108. For example, the machine learning model can be trained using the query point, first image 106, and second image 108 as input training data and the corresponding point at second image 108 as output training data. As such, once trained, the machine learning model can receive a first image, query point at the first image, and a second image, and output the point corresponding to query point at the second image (e.g., without having to generate set of region pairs and/or identify a region of interest).

In some implementations, techniques described herein can be used in civilian applications, such as augmented reality (AR) point placement, robotics and autonomous navigation, medical image registration for specific anatomical points, photogrammetry, and 3D reconstruction. In some implementations, techniques described herein can be used in industrial applications, such as quality control inspection, precision manufacturing alignment, remote sensing, and satellite imagery analysis.

Although FIG. 1 illustrates a single compute device, in some implementations, multiple compute devices can be used. For example, a first compute device can be used to determine first set of regions 110 and second set of regions 112, and a second compute device can be used to determine filtered region 114 and region of interest 116. In such an implementation, the first compute device can provide the determined first set of regions 110 and second set of regions 112 to the second compute device for further processing to determine filtered region 114 and region of interest 116.

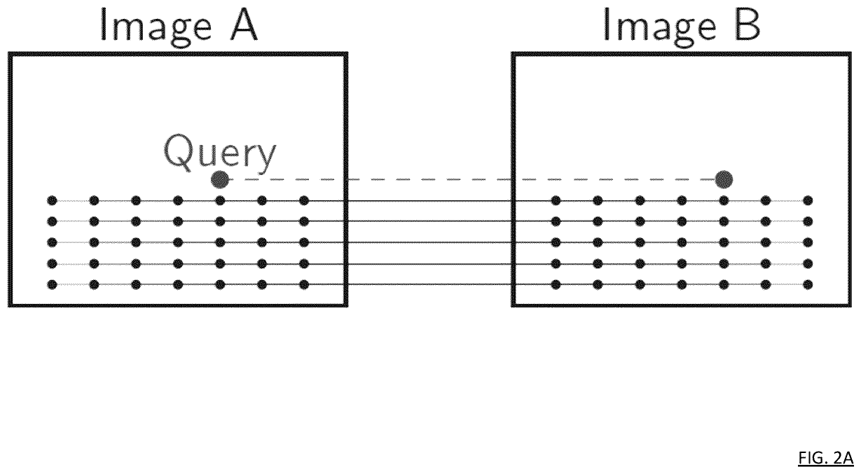

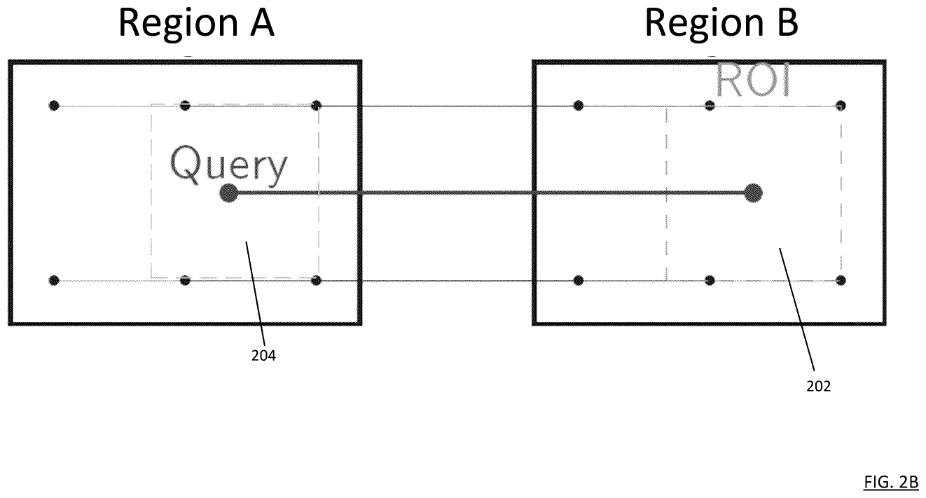

FIG. 2A is a diagram illustrating a known approach to matching. A brute force approach is applied, where various pixels from various regions from image A are compared to various pixels from various regions from image B until a pixel at image B matching the query point is found. In contrast, FIG. 2B is a diagram illustrating an example of an approach to matching disclosed herein. At FIG. 2B, six points that match between region A (e.g., included in first set of regions 110) and region B (e.g., included in second set of regions 112) are identified using a first matching technique. Region A is analyzed to determine filtered region 204, where filtered region 204 represents a sub-region of region A having a distance, feature space similarity, and/or semantic similarity within a predetermined acceptable range of the query point at image A. The remaining two points that are not included in filtered region 204 are pixels that were filtered out in response to identifying that each point from the remaining two points did not have a distance, feature space similarity, and/or semantic similarity within the predetermined acceptable range of the query point at image A. Region B is then analyzed to determine a region that corresponds to filtered region 204, which at FIG. 2B is (or defines) region of interest 202. Region of interest 202 is analyzed (but not areas outside region of interest 202 at Image B) using a second matching technique (e.g., that is more computationally complex than the first matching technique) to identify a point at image B that matches the query point from image A.

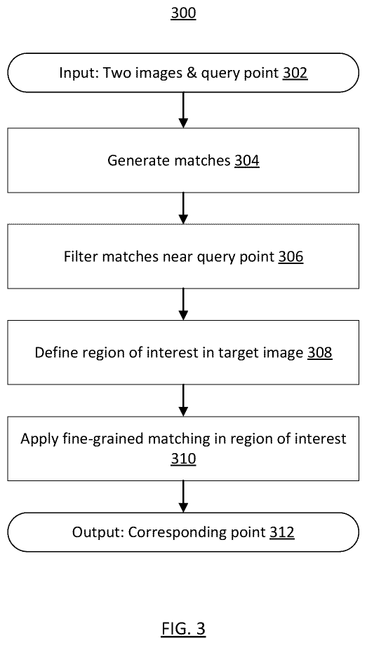

FIG. 3 is a flowchart of a method 300 to determine a corresponding point, according to an embodiment. In some implementations, method 300 is stored as instructions in a memory (e.g., memory 104 of FIG. 1) and is performed by a processor (e.g., processor 102 of FIG. 1). At 302, two images (e.g., first image 106 and second image 108) and a query point identified at one image are identified/prepared as the input. At 304, matches (e.g., first set of regions 110 and second set of regions 112) are generated using a first matching technique. Matches can represent predicted matching regions between the two images. At 306, filtering occurs to identify at least a subset of matches from the matches generated at 304 that are near the query point, to define the filtered region (e.g., filtered region 114), and to identify remaining matches from the matches generated at 304 that are not near the query point. For example, the filtered region can include points that each have a distance (e.g., a Euclidean distance, etc.) relative to the query point and that satisfies a predetermined acceptable range of distances. Instead, or in addition, the filtered region can include points that collectively have a feature space similarity to a region including the query point and that satisfies a predetermined acceptable degree of feature space similarity. Instead, or in addition, the filtered region can include points that collectively have a semantic relevance with a region including the query point and that satisfies a predetermined acceptable degree of semantic relevance. A region of interest (e.g., region of interest 116) is defined at 308 by identifying the region(s) at the second image that matches the filtered region identified at 306. Fine-grained matching is applied at the region of interest during 310 to generate a corresponding point as output for 312.

Fine-grained matching can be, for example, a matching technique that is more computationally complex than the first matching technique associated with generating the matches at 304, which can be “coarse” matching. For example, fine-grained matching can have, relative to coarse matching, a longer processing time/higher time complexity (e.g., based on a larger number of elementary operations such as additions, comparisons, etc. used to complete a task), a requirement for larger memory/higher space complexity (e.g., a maximum amount of working memory or storage space required during execution), a requirement for more processing resources (e.g., a number of processing units, an amount of CPU power, etc.), a requirement for more data (e.g., more samples in a dataset, more nodes in a network, greater length of a bit string, etc.), a requirement for a larger model size (e.g., more parameters/weights), and/or the like. Fine-grained matching can be and/or include, for example, brute force matching, scale-invariant feature transform (SIFT), speeded-up robust features (SURF), oriented FAST and rotated BRIEF (ORB), RANdom Sample Consensus (RANSAC), attention-based cross-transformers, and/or the like. Coarse matching can be and/or include, for example, vector-encoded feature lookups against a database, vector-encoded region matching via cosine similarity (or dot-product), region matching via color histogram comparison, and/or the like. In some implementations, coarse matching does not include point-by-point matching between the first image and the second image. For example, in some implementations, coarse matching does not include comparing a point from a plurality of points in the first image to one or more points from a plurality of points in the second image.

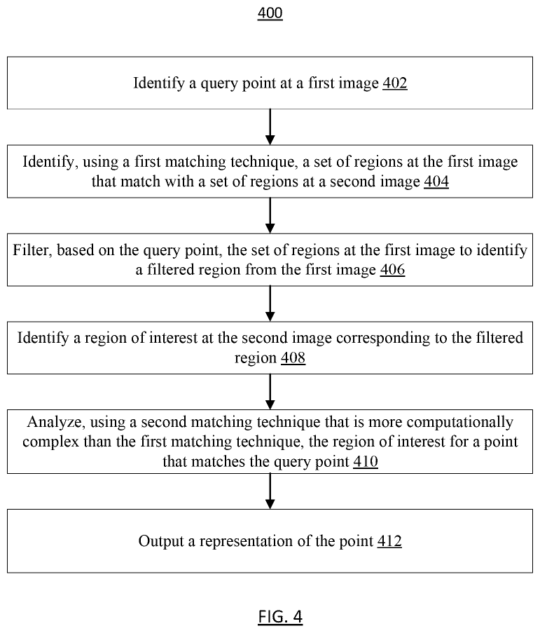

FIG. 4 illustrates a flowchart of a method 400 to identify a point at a second image matching a query point at a first image, according to an embodiment. In some implementations, method 400 is stored as instructions in a memory (e.g., memory 104 of FIG. 1) and is performed by a processor (e.g., processor 102 of FIG. 1).

At 402, a query point is identified at a first image (e.g., first image 106 of FIG. 1). The query point can be identified without user intervention in some implementations, and based on user input in other implementations. In some implementations, the first image is captured by a first camera (e.g., camera 120 of FIG. 1) and the second image is captured by a second camera (e.g., optional camera 130 of FIG. 1). In some implementations, the first image and the second image are captured by a same camera (e.g., camera 120 of FIG. 1). In some implementations, the first image is captured at a first time and the second image is captured at a second time different than the first time.

At 404, a set of regions at the first image (e.g., first set of regions 110) that match with a set of regions at a second image (e.g., second set of regions 112) are identified using a first matching technique. In some implementations, the first matching technique can be and/or include coarse matching. For example, identifying the set of regions at the first image can include encoding the set of regions at the second image to define a first vector, encoding a plurality of regions that includes the set of regions at the first image to define a plurality of second vectors, and comparing the first vector (e.g., via a cosine similarity or dot product) to each second vector from the plurality of second vectors to identify the second vector from the plurality of second vectors that has a highest cosine similarity or highest dot product. As another example, identifying the set of regions at the first image can include processing the set of regions at the second image to generate a first color histogram, processing a plurality of regions that includes the set of regions at the first image to generate a plurality of second color histograms, and comparing the first color histogram to each second color histogram from the plurality of second color histograms to identify the second color histogram from the plurality of second color histograms that most closely matches the first color histogram.

At 406, the set of regions are filtered, based on the query point, to identify (or define) a filtered region (e.g., filtered region 114 of FIG. 1) from the first image. The filtered region includes regions from the set of regions at the first image that meet a predetermined set of one or more criteria. In some implementations, filtering the set of regions to identify the filtered region at 406 includes identifying regions from the set of regions having a Euclidean distance within a predetermined acceptable range of the query point. In some implementations, filtering the set of regions to identify the filtered region at 406 includes identifying regions from the set of regions having a feature space similarity within a predetermined acceptable range of the query point. In some implementations, filtering the set of regions to identify the filtered region at 406 includes identifying regions from the set of regions having a semantic relevance within a predetermined acceptable range of the query point. The filtered region does not include regions from the set of regions at the first image that do not meet a predetermined set of one or more criteria including, for example, a first criterion associated with a Euclidean distance from the query point, a second criterion associated with a feature space similarity to a region including the query point, and/or a third criterion associated with a semantic relevance to a region including the query point.

At 408, a region of interest (e.g., region of interest 116 of FIG. 1) at the second image corresponding to the filtered region is identified. In some implementations, identifying the region of interest can include comparing the filtered region at the first image to a plurality of regions at the second image to identify the region from the plurality of regions at the second image that matches the filtered region. In some implementations, identifying the region of interest can include using the first matching technique. In some implementations, identifying the region of interest can include using coarse matching, as described elsewhere herein.

At 410, the region of interest is analyzed, using a second matching technique that is more computationally complex than the first matching technique, for a point that matches the query point. In some implementations, the second matching technique can be and/or include brute force matching. For example, analyzing the region of interest can include comparing at least a subset of points (and in some instances, every point) in the region of interest to the query point to identify the point from the at least the subset of points in the region of interest that matches the query point. In some implementations, the second matching technique can be and/or include SIFT, SURF, ORB, RANSAC, and/or the like.

At 410, a representation of the point is output. The representation can be an indicator that represents information about the point. In some implementations, the method 400 can include storing the representation for example in a memory or a database for downstream processing such as tracking an object that includes the point, reconstructing the object that includes the point to generate a 3D representation of the object, and/or the like. In some implementations, the method 400 can include causing display of the representation for example on a display. In some implementations, the display can be operatively coupled to the processor that implements method 400. In some implementations, the display can be included with (or within) a head-mounted display (e.g., head-mounted display 101 of FIG. 1). The representation can be, for example, a visual indicator such as, for example, a bounding box, a dot, a shape, a color, a saturation, a contrast, a brightness, a resolution, text, and/or the like. In some implementations, the representation can include coordinates of the point. For example, the coordinates can be relative coordinates that represent a relative location of the point with respect to a user of a compute device (and/or a head-mounted display), with respect to another object in the second image, and/or with respect to a pixel origin (or reference point) in the second image. In some instances, the coordinates can be global coordinates that represent a global location of the point, such as Global Positioning System (GPS) coordinates, and/or the like.

In some implementations, techniques described herein can be applied for head-mounted displays, such as the head-mounted display disclosed in U.S. patent application Ser. No. 19/072,793 and/or Ser. No. 19/049,754, which are each incorporated herein by reference. In an embodiment, a head-mounted display includes a set of cameras, a display, and a processor operatively coupled to at least one of the set of cameras or the display. The processor is configured to cause the set of cameras to capture a first image and a second image. The processor is further configured to identify a query point at a first image. The processor is further configured to identify, using a first matching technique, a set of regions at the first image that match with a set of regions at the second image. The processor is further configured to filter, based on the query point, the set of regions at the first image to identify a filtered region. The processor is further configured to identify a region of interest at the second image corresponding to the filtered region. The processor is further configured to analyze, using a second matching technique that is more computationally complex than the first matching technique, the region of interest for a point matching the query point. The processor is further configured to output a representation of the point at the display.

In some embodiments, a method comprises: identifying, via a processor, a query point at a first image; identifying, via the processor and using a first matching technique, a set of regions at the first image that match with a set of regions at a second image; filtering, via the processor and based on the query point, the set of regions at the first image to identify a filtered region from the first image; identifying, via the processor, a region of interest at the second image corresponding to the filtered region; analyzing, via the processor and using a second matching technique that is more computationally complex than the first matching technique, the region of interest for a point that matches the query point; and outputting, via the processor, a representation of the point.

In some such implementations, filtering the set of regions to identify the filtered region includes: identifying regions from the set of regions having a Euclidean distance within a predetermined acceptable range of the query point.

In some such implementations, filtering the set of regions to identify the filtered region includes: identifying regions from the set of regions having a feature space similarity within a predetermined acceptable range of the query point.

In some such implementations, filtering the set of regions to identify the filtered region includes: identifying regions from the set of regions having a semantic relevance within a predetermined acceptable range of the query point.

In some such implementations, the query point is identified without user intervention.

In some such implementations, the query point is identified based on user input.

In some such implementations, the first image is captured by a first camera and the second image is captured by a second camera.

In some such implementations, the first image is captured at a first time and the second image is captured at a second time different than the first time.

In some such implementations, the first image and the second image are captured by at least one camera included in a head-mounted display, and the representation of the point is output at a display included in the head-mounted display.

In some embodiments, a head-mounted display comprises: a set of cameras; a display; and a processor operatively coupled to at least one of the set of cameras or the display, the processor configured to: cause the set of cameras to capture a first image and a second image; identify a query point at the first image; identify, using a first matching technique, a set of regions at the first image that match with a set of regions at the second image; filter, based on the query point, the set of regions at the first image to identify a filtered region from the first image; identify a region of interest at the second image corresponding to the filtered region; analyze, using a second matching technique that is more computationally complex than the first matching technique, the region of interest for a point that matches the query point; and output a representation of the point.

In some such implementations, to filter the set of regions to identify the filtered region, the processor is configured to identify regions from the set of regions having a Euclidean distance within a predetermined acceptable range of the query point.

In some such implementations, to filter the set of regions to identify the filtered region, the processor is configured to identify regions from the set of regions having a feature space similarity within a predetermined acceptable range of the query point.

In some such implementations, to filter the set of regions to identify the filtered region, the processor is configured to identify regions from the set of regions having a semantic relevance within a predetermined acceptable range of the query point.

In some such implementations, the query point is identified without user intervention.

In some such implementations, the query point is identified based on user input.

In some such implementations, the first image is captured at a first time and the second image is captured at a second time different than the first time.

In some such implementations, the representation of the point is output at the display, and the representation includes coordinate values of the point.

In some embodiments, a non-transitory, processor-readable medium stores instructions that, when executed by at least one processor, cause the at least one processor to: identify a query point at a first image; identify, using a first matching technique, a set of regions at the first image that match with a set of regions at a second image; filter, based on the query point, the set of regions at the first image to identify a filtered region from the first image; identify a region of interest at the second image corresponding to the filtered region; analyze, using a second matching technique that is more computationally complex than the first matching technique, the region of interest for a point that matches the query point; and cause display of a representation of the point.

In some such implementations, each of the non-transitory, processor-readable medium and the processor is included with a head-mounted display.

In some such implementations, the instructions to cause the at least one processor to identify, using the first matching technique, the set of regions, include instructions to cause a first processor from the at least one processor to identify, using the first matching technique, the set of regions, and the instructions to cause the at least one processor to analyze, using the second matching technique, the region of interest, include instructions to cause a second processor from the at least one processor to analyze, using the second matching technique, the region of interest, the second processor being included in a first compute device that is different from a second compute device that includes the second processor.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used in this specification and the appended claims, the singular forms “a,” “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and/or “approximately” when used in conjunction with numerical values and/or ranges generally refer to those numerical values and/or ranges near to a recited numerical value and/or range. For example, in some instances, “about 40 [units]” can mean within ±25% of 40 (e.g., from 30 to 50). In some instances, the terms “about” and “approximately” can mean within ±10% of the recited value. In other instances, the terms “about” and “approximately” can mean within ±9%, ±8%, ±7%, ±6%, ±5%, ±4%, ±3%, ±2%, ±1%, less than ±1%, or any other value or range of values therein or therebelow. The terms “about” and “approximately” may be used interchangeably. Furthermore, although a numerical value modified by the term “about” or “approximately” can allow for and/or otherwise encompass a tolerance of the stated numerical value, it is not intended to exclude the exact numerical value stated.

In a similar manner, term “substantially” when used in connection with, for example, a geometric relationship, a numerical value, and/or a range is intended to convey that the geometric relationship (or the structures described thereby), the number, and/or the range so defined is nominally the recited geometric relationship, number, and/or range. For example, two structures described herein as being “substantially non-parallel” is intended to convey that, although a non-parallel geometric relationship is desirable, some parallelism can occur in a “substantially non-parallel” arrangement. Such tolerances can result from manufacturing tolerances, measurement tolerances, and/or other practical considerations (such as, for example, minute imperfections, age of a structure so defined, a pressure or a force exerted within a system, and/or the like). As described above, a suitable tolerance can be, for example, of ±1%, ±2%, ±3%, +4%, ±5%, ±6%, ±7%, ±8%, ±9%, ±10%, or more of the stated geometric construction, numerical value, and/or range. Furthermore, although a numerical value modified by the term “substantially” can allow for and/or otherwise encompass a tolerance of the stated numerical value, it is not intended to exclude the exact numerical value stated.

The specific configurations of the various components described herein can also be varied. For example, the size and specific shape of the various components can be different from the embodiments shown, while still providing the functions as described herein. Additionally, the relative size of various components of the devices shown and described herein with respect to the size of other components of the devices are not necessarily to scale.

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of processes, services, and/or the like may be performed or occur serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others. Similarly, where methods and/or events described above indicate certain events and/or procedures occurring in certain order, the ordering of certain events and/or procedures may be modified. While the embodiments have been particularly shown and described, it will be understood that various changes in form and details may be made.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™M, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting.

What is claimed is:

1. A method, comprising:
identifying, via a processor, a query point at a first image;
identifying, via the processor and using a first matching technique, a set of regions at the first image that match with a set of regions at a second image;
filtering, via the processor and based on the query point, the set of regions at the first image to identify a filtered region from the first image;
identifying, via the processor, a region of interest at the second image corresponding to the filtered region;
analyzing, via the processor and using a second matching technique that is more computationally complex than the first matching technique, the region of interest for a point that matches the query point; and
outputting, via the processor, a representation of the point.

2. The method of claim 1, wherein filtering the set of regions to identify the filtered region includes:
identifying regions from the set of regions having a Euclidean distance within a predetermined acceptable range of the query point.

3. The method of claim 1, wherein filtering the set of regions to identify the filtered region includes:
identifying regions from the set of regions having a feature space similarity within a predetermined acceptable range of the query point.

4. The method of claim 1, wherein filtering the set of regions to identify the filtered region includes:
identifying regions from the set of regions having a semantic relevance within a predetermined acceptable range of the query point.

5. The method of claim 1, wherein the query point is identified without user intervention.

6. The method of claim 1, wherein the query point is identified based on user input.

7. The method of claim 1, wherein the first image is captured by a first camera and the second image is captured by a second camera.

8. The method of claim 1, wherein the first image is captured at a first time and the second image is captured at a second time different than the first time.

9. The method of claim 1, wherein the first image and the second image are captured by at least one camera included in a head-mounted display, and the representation of the point is output at a display included in the head-mounted display.

10. A head-mounted display, comprising:
a set of cameras;
a display; and
a processor operatively coupled to at least one of the set of cameras or the display, the processor configured to:
cause the set of cameras to capture a first image and a second image;
identify a query point at the first image;
identify, using a first matching technique, a set of regions at the first image that match with a set of regions at the second image;
filter, based on the query point, the set of regions at the first image to identify a filtered region from the first image;
identify a region of interest at the second image corresponding to the filtered region;
analyze, using a second matching technique that is more computationally complex than the first matching technique, the region of interest for a point that matches the query point; and
output a representation of the point.

11. The head-mounted display of claim 10, wherein the processor is configured to filter by identifying regions from the set of regions having a Euclidean distance within a predetermined acceptable range of the query point.

12. The head-mounted display of claim 10, wherein the processor is configured to filter by identifying regions from the set of regions having a feature space similarity within a predetermined acceptable range of the query point.

13. The head-mounted display of claim 10, wherein the processor is configured to filter by identifying regions from the set of regions having a semantic relevance within a predetermined acceptable range of the query point.

14. The head-mounted display of claim 10, wherein the query point is identified without user intervention.

15. The head-mounted display of claim 10, wherein the query point is identified based on user input.

16. The head-mounted display of claim 10, wherein the first image is captured at a first time, and the second image is captured at a second time different than the first time.

17. The head-mounted display of claim 10, wherein:
the representation of the point is output at the display, and the representation includes coordinate values of the point.

18. A non-transitory, processor-readable medium storing instructions that, when executed by at least one processor, cause the at least one processor to:
identify a query point at a first image;
identify, using a first matching technique, a set of regions at the first image that match with a set of regions at a second image;
filter, based on the query point, the set of regions at the first image to identify a filtered region from the first image;
identify a region of interest at the second image corresponding to the filtered region;
analyze, using a second matching technique that is more computationally complex than the first matching technique, the region of interest for a point that matches the query point; and
cause display of a representation of the point.

19. The non-transitory, processor-readable medium of claim 18, wherein each of the non-transitory, processor-readable medium and the processor is included with a head-mounted display.

20. The non-transitory, processor-readable medium of claim 18, wherein:
the instructions to cause the at least one processor to identify, using the first matching technique, the set of regions, include instructions to cause a first processor from the at least one processor to identify, using the first matching technique, the set of regions, and
the instructions to cause the at least one processor to analyze, using the second matching technique, the region of interest, include instructions to cause a second processor from the at least one processor to analyze, using the second matching technique, the region of interest,
the second processor being included in a first compute device that is different from a second compute device that includes the second processor.
